(19) United States
(12) Patent Application Publication
(10) Pub. No.: US 2014/0233390 A1
(43) Pub. Date: Aug. 21, 2014

(54) METHOD AND SYSTEM FOR CONGESTION AVOIDANCE IN MOBILE COMMUNICATION NETWORKS

(71) Applicant: NEC EUROPE LTD., Heidelberg (DE)

(72) Inventors: Stefan Schmid, Heidelberg (DE); Gottfried Punz, Dossenheim (DE); Toshiyuki Tamura, Kawasaki (JP)

(73) Assignee: NEC EUROPE LTD., Heidelberg (DE)

(21) Appl. No.: 14/343,170

(22) PCT Filed: Sep. 6, 2012
(86) PCT No.: PCT/EP2012/067459

§ 371 Date: Apr. 29, 2014

(30) Foreign Application Priority Data
Sep. 6, 2011 (EP) 11007226.1

(51) Int. Cl. H04W 28/02; H04L 12/803

(52) U.S. Cl. CPC H04W 28/0289; H04W 28/0284; H04W 28/0273; H04L 47/125
USPC 370/236

(57) ABSTRACT

In a method for congestion avoidance in mobile communication networks, the mobile communication network includes a sender and a receiver, one located in a mobile network, the mobile network being connected to a network of the mobile communication network. Steps include: detecting congestion in a first communication plane of the mobile communication network between the sender and the receiver; b) providing a congestion notification further downstream in the direction of a data transmission path between the sender and the receiver; c) providing congestion notification information on the opposite data transmission path on a second communication plane of the mobile communication network; and d) initiating congestion avoidance. The congestion notification and congestion notification information are transmitted between mobile network entities. The data transmission path and the opposite data transmission path are on the same communication plane.

The invention relates to a method for congestion avoidance in a mobile communication network, wherein the mobile communication network comprises a sender and a receiver, wherein one of them is located in a mobile access network of the mobile communication network, comprising the steps of
a) Indicating a congestion in a data transmission of the mobile communication network between the sender and the receiver,
b) Providing a congestion notification further downstream in the direction of the data transmission path between the sender and the receiver,
c) Providing congestion notification information on the data transmission path in opposite direction,
d) Receiving and evaluating the congestion notification information and
e) Initiating one or more congestion avoidance policies based on the evaluated congestion notification information.

The invention relates further to a system for congestion avoidance in a mobile communication network, wherein the mobile communication network comprises a sender and a receiver, wherein one of them is located in a mobile access network of the mobile communication network, preferably for performing with a method according to one of the claims 1-18, and wherein the mobile network comprises a plurality of entities, and at least one action entity,

wherein at least one of the entities is configured to be operable to indicate a congestion in a data transmission of the mobile communication network between the sender and the receiver, and to provide a congestion notification further downstream in the direction of the data transmission path between the sender and the receiver, and wherein
one of the entities is configured to be operable to provide congestion notification information on the data transmission path in opposite direction and wherein the action entity is configured to be operable to initiate one or more congestion avoidance policies based on evaluated congestion notification information.

Although applicable in general to congestions on any communication plane in mobile communication networks, the present invention will be described with regard to a congestion in a user plane of the mobile communication network.

The deployment of broadband wireless access technologies like HSPDA, HSPA or LTE and the immense success of smart phones and tablet PCs as well as new types of data services that can be accessed by those mobile devices lead to a very fast data rate growth in mobile communication networks. Carriers of the mobile communication networks have the problem that they cannot cope with that growth when upgrading their mobile communication network capacities. Over-provisioning of the mobile communication networks like today is therefore not possible anymore in the near future. As a consequence congestion in the user plane is more likely to occur.

For example for radio congestion an operator of the mobile communication network is facing the problem that an accurate charging cannot be provided to the end user, i.e. the user equipment of the end user, since download packets are discarded in the base station to which the user equipment is connected while a charging function is located in entities of a core network, for example a packet data network gateway or the serving gateway for the roaming case.

A conventional method to indicate network congestion is ECN as defined in RFC 3168. ECN allows network entities, for example a Gateway GPRS support node GGSN/Serving GPRS Support node SSGN/radio network controller RNC/node B NB in a GPRS/EPS network or a packet data network gateway P-GW/serving gateway S-GW/evolved node B eNB in EPS/LTE network as well as routers and switches in the mobile backhaul network or in the mobile transport network to set an ECN indication in the IP header of user plane packets when a congestion has occurred. The ECN indication is signaled to the data sink, i.e. the receiver of the data packet, which will upon receipt of the ECN indication either try to downgrade a sending rate, for example by renegotiating a media codec in case of voice or multimedia communication, through application-level control signaling or signal to the sender via transport protocol signaling that the corresponding network is congested, for example in corresponding TCP acknowledgements according to IETF RFC 5562. The data source, i.e. the sender then is enabled to reduce the sending rate which may help to overcome the network congestion.

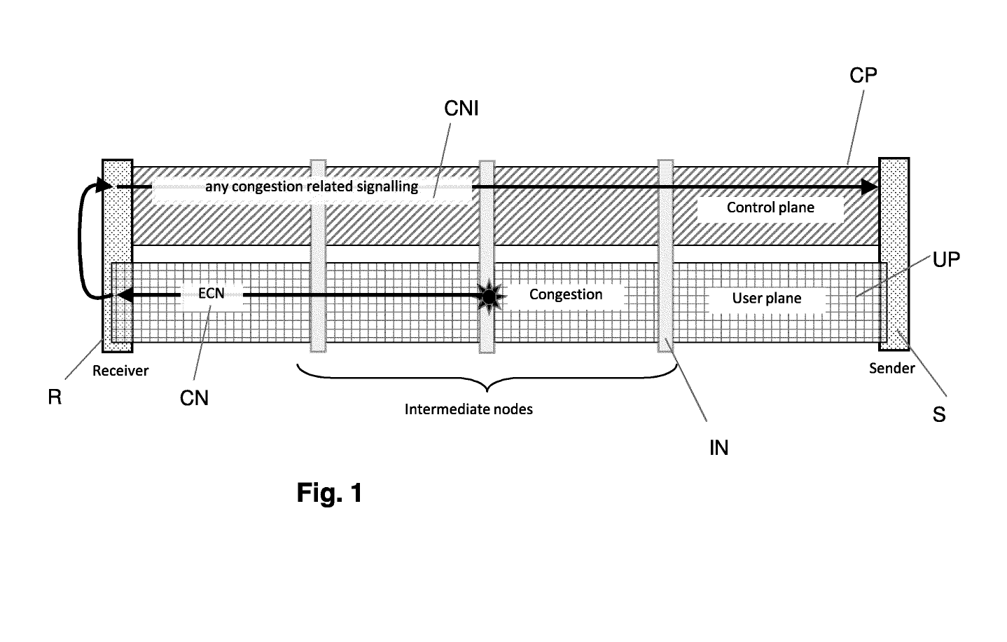

In FIG. 1 a conventional overall scheme of a congestion signaled with ECN is shown. A sender S and a receiver R are connected via intermediate nodes IN in the user plane UP and in the control plane CP. When a congestion C occurs at one of the intermediate nodes IN a congestion notification CN in form of an ECN is transmitted to the receiver R. The receiver R then sends a congestion notification information on the control plane CP to the sender S. The sender S may then for example reduce the sending rate to overcome the detected network congestion in the user plane UP.

One of the disadvantages of the conventional ECN method is that sender, receiver as well as intermediate nodes need to support ECN according to IETF RFC 3168. Another disadvantage is, that such a congestion notification is accompanied with a relatively high delay until congestion is reduced since congestion control is done end-to-end between the sender and the receiver. An even further disadvantage is, that congestion notification via ECN requires an extension of all transport and application protocols, since the congestion feedback from the receiver to the sender is signaled only via application and/or transport level control channels.

In the following the term “congestion avoidance” includes also mitigation of congestion.

It is therefore an objective of the present invention to provide a method and a system for congestion avoidance which allow a cost-effective congestion notification.

It is a further objective of the present invention to provide a method and a system for congestion avoidance which are easy to implement.

It is an even further objective of the present invention to provide a method and a system for congestion avoidance which provide an increased flexibility in particular with regard to congestion avoidance actions taking into account various different mobile communication network structures.

According to the invention the aforementioned objectives are accomplished by a method of claim 1 and a system of claim 19.

According to claim 1 the method a method for congestion avoidance in a mobile communication network, wherein the mobile communication network comprises a sender and a receiver, wherein one of them is located in a mobile access network of the mobile communication network, comprising the steps of
a) Indicating a congestion in a data transmission of the mobile communication network between the sender and the receiver,
b) Providing a congestion notification further downstream in the direction of the data transmission path between the sender and the receiver,
c) Providing congestion notification information on the data transmission path in opposite direction,
d) Receiving and evaluating the congestion notification information and
e) Initiating one or more congestion avoidance policies based on the evaluated congestion notification information.

According to the invention the method of claim 1 is characterized in that the congestion notification according to step b) and the congestion notification information according to step c) are transmitted between mobile network entity on the same communication plane of the mobile communication network and that the congestion notification information according to step c) is provided with a granularity level more coarse than the IP flow level to an action function for performing steps d) and/or e).

According to claim 19 the system for congestion avoidance in a mobile communication network, wherein the mobile communication network comprises a sender and a receiver, wherein one of them is located in a mobile access network of the mobile communication network, preferably for performing with a method according to one of the claims 1-18, and wherein the mobile network comprises a plurality of entities, and at least one action entity,

wherein at least one of the entities is configured to be operable to indicate a congestion in a data transmission of the mobile communication network between the sender and the receiver, and to provide a congestion notification further downstream in the direction of the data transmission path between the sender and the receiver, and wherein
one of the entities is configured to be operable to provide congestion notification information on the data transmission path in opposite direction and wherein the action entity is configured to be operable to initiate one or more congestion avoidance policies based on evaluated congestion notification information.

According to claim 19 the system is characterized in that at least two of the entities of the mobile access network are configured to be operable to transmit the congestion notification and the congestion notification information according to step c) between on the same communication plane of the mobile communication network and that at least one of the two entities is configured to be operable to provide the congestion notification information with a granularity level more coarse than the IP flow level to the action entity for receiving and evaluating the congestion notification information and/or for initiating one or more congestion avoidance policies.

According to the invention it has first been recognized that the method and the system enable a congestion related feedback in particular in the user plane between mobile (communication) network entities of the mobile communication network.

According to the invention it has further been first recognized that counter measures for congestion avoidance can be triggered more easily when providing congestion notification and/or congestion notification information also to the control plane in particular to a policy related network function like the Policy and Charging Rule Function or the like.

According to the invention it has further been first recognized that the method and the system provide an enhanced flexibility since a limitation to specific protocols is not necessary.

According to the invention it has further been first recognized that the method and the system are easy to implement and enable a very flexible and a simple way to avoid, reduce or mitigate congestions after congestion has occurred.

Further features, advantages and preferred embodiments are described in the following subclaims.

According to a preferred embodiment the congestion notification according to step b) and/or the congestion notification information according to step c) is transmitted between edge entities of the mobile communication network. Edge entities are entities of the mobile communication network in the user plane handling data traffic. This enables for example provisioning of congestion indication feedback to ingress routers/gateways of the mobile (communication) network for downlink traffic and to a base station or even a user equipment for uplink traffic so that those “ingress” or edge entities may limit the data traffic entering the mobile communication network already at the corresponding mobile communication network border. For example this may allow a GGSN, a P-GW, a S-GW or a Traffic Detection Function TDF to perform traffic shaping, packet dropping or the like for downlink traffic to counteract congestion within the mobile communication network, or a base station or a user equipment to perform traffic shaping, packet dropping or the like for uplink traffic to counteract congestion within the mobile communication network.

According to a further preferred embodiment mobile network related information is added to the congestion notification information, preferably mobile network entity or service related information. Mobile network related information in particular mobile network entity related information may for example be information about a cell of a base station as mobile network entity to which a user equipment is connected. This enhances the flexibility of the method even further, since such information enables more optimized or more accurate congestion avoidance actions or congestion avoidance policies to be imposed.

According to a further preferred embodiment the one or more congestion avoidance policies, preferably traffic engineering policies and/or Quality of Service policies, are chosen based on the mobile network related information. Such information may for example include cell identity, location area, routing area, tracking area, closed subscriber group CSG, EPS cell global identity or the like. This additional information may be used for example by a GGSN, a packet data network gateway P-GW or a traffic detection function TDF to apply congestion avoidance policies in form of traffic engineering policies not only to uplink traffic but also to downlink traffic of other user equipment served by the specific cell or that are associated to that local area routing area and/or tracking area, closed subscriber group or EPS cell global identity.

According to a further preferred embodiment the congestion notification information is provided to a congestion avoidance policy control function for choosing one or more congestion avoidance policies and the chosen congestion avoidance policies are provided to the action function for initiation. Traffic engineering policies for example and/or quality of service policies as congestions avoidance policies enable a very flexible adaption to underlying communication between the sender and the receiver and/or the structure of the mobile communication network. For example traffic engineering policies may comprise a set of traffic flow templates (TFTs) to identify traffic flows to which the traffic engineering policies should apply. Further one or more of the following actions may also be applied as traffic engineering policy: a) rate limiting and/or traffic shaping, b) extended buffering with intelligence scheduling for achieving fairness among different user equipment and/or flows and/or accounts for user and/or traffic priority and/or accounts for application requirements, c) intelligent packet dropping, for example drop certain portion of frames, for example low-priority video frames in MPEG, d) triggering a handover of IP flows to other accesses if available, e) change (AMR) codec value, preferably on the behalf of a user equipment and f) traffic redirection to a dedicated entity or node, for example a media gateway or a compressor. By providing the congestion notification information to the congestion avoidance policy control function, this enables a flexible way to dynamically adapt or choose appropriate congestion avoidance policies to be initiated by the action function.

According to a further preferred embodiment the one or more congestion avoidance policies are imposed on different data traffic with respect to a granularity level more coarse than the IP flow level in the user plane on the congested data transmission path. This even further enhances the flexibility of the method, since for example low priority bearers other than the user traffic, bearer(s), tunnel(s) and/or IP flows for which a congestion was detected and which share the same core network of the mobile communication network, backhaul or radio access links may be limited according to one or more congestion avoidance actions. The granularity level here may be different from the granularity level with respect to the congestion notification information.

According to a further preferred embodiment a congestion is detected on a granularity level of a user equipment, bearer, tunnel and/or IP flow in the user plane. This allows a fast and reliable as well as simple detection of a congestion in the user plane. Further a plurality of conventional congestion avoidance actions or policies may be performed to avoid or at least reduce the detected congestion.

According to further preferred embodiment the congestion notification information is provided in form of an echo message of the congestion notification. This enables in an easy and simple way to provide a corresponding congestion notification information for the congestion notification without introducing new messages and/or procedures for providing congestion notification information.

According to a further preferred embodiment congestion notification information and/or congestion notification is included into the data transmission between edge entities, preferably included as an additional IPv4 option and/or as an additional IPv6 extension header and/or as new GTP header field. This enables for example piggybacking congestion information on the user plane data traffic without the need to introduce further data or message exchange.

According to a further preferred embodiment congestion notification information and/or congestion notification is included into signaling messages, preferably included in a GTP control plane message, between mobile network entities, preferably edge entities. This enables for example to indicate congestion or transmit congestion notification information and/or congestion information piggybacking a new congestion indicator onto existing messages and/or echo messages that are exchanged between mobile network entities on the control plane.

According to a further preferred embodiment a congestion notification information and/or congestion notifications are provided repeatedly as long as congestion is present. This enables a very simple initiation of one or more congestion avoidance actions by analyzing if corresponding congestion notifications or corresponding congestion notification information are present or not. As long as such notifications are present one or more congestion avoidance actions or policies are initiated respectively imposed and these actions/policies are stopped if corresponding congestion notifications and/or congestion notification information are not present anymore.

According to a further preferred embodiment the one or more congestion avoidance policies are initiated when a counting threshold for a number of congestion notification information and/or congestion notifications is exceeded during a certain time interval. This enables a very simple and easy to implement initiation of one or more congestion avoidance actions by simply counting a number of congestion notifications and congestion notification information within a certain time interval. For example in case of a downlink congestion, i.e. the receiver is a user equipment a packet data network gateway P-GW or a traffic detection function TDF counts data packets that have i) the congestion notification set in the downlink direction and ii) the congestion notification information set in the uplink direction on for example per bearer, per user equipment or per radio cell basis. If the percentage of data packets with the congestion notification information set is higher than the percentage of packets with congestion notification set, then the packet data network gateway P-GW or the traffic detection function TDF provides the congestion notification information to the Policy and Charging Rule Function PCRF to inform it about the downlink congestion level. The Policy and Charging Rule Function PCRF then selects and provides appropriate traffic engineering policies TEP to an edge entity P-GW, TDF which then in turn imposes or enforces the corresponding traffic engineering policy TEP.

According to a further preferred embodiment the congestion notification information and/or congestion notifications are provided with a preconfigured frequency when a congestion is present. This avoids that, for example the packet data network gateway P-GW and/or Policy and Charging Rule Function PCRF is flooded with congestion notifications and/or congestion notification information. For example a packet data network gateway P-GW or a traffic detection function TDF that as detected several bearers, user equipment or cells for which congestion has occurred during a last reporting period will send a list of these user equipment, bearers and/or cells that are congested in bulk to the and Charging Rule Function PCRF.

According to a further preferred embodiment congestion notification information and/or congestion notifications include start/begin and/or stop/end congestion indication commands. This enables for example to reduce the information to be provided for indicating a congestion. For example when a congestion occurs a start command for congestion notification is provided and when the congestion has disappeared a stop command for congestion indication is provided. Regular further traffic by providing periodically congestion notification and/or congestion notification information is avoided thus saving network resources.

According to a further preferred embodiment a congestion and/or an end of a congestion is determined by comparing a number of congestion notification information and an number of congestion notifications. This enables for example by simply comparing a number of congestion notification information and a number of congestion notifications to determine that the congestion is over. When for example a percentage of congestion notification information received by a packet data network gateway P-GW or a traffic detection function TDF in an uplink direction is again equal to or only a little higher, depending on the granularity level, than the percentage of congestion notifications seen by the packet data network gateway P-GW or the traffic detection function TDF in the downlink direction over a defined time interval, then the corresponding congestion for a user equipment can be considered to have stopped. In case of an uplink user plane congestion, a base station may for example detect that the user plane congestion in uplink direction is over, if the number of packets with congestion notification information is back to zero over a defined evaluation or time interval. Then no further congestion notifications are present and the congestion period for a user equipment can be considered over.

According to a further preferred embodiment the numbers of congestion notifications and of congestion notification information are provided as percentage values representing the fraction of data traffic packets with and without congestion notifications and congestion notification information. This enables for example a packet data network gateway P-GW, a GGSN or a Policy and Charging Rule Function PCRF to detect more easily if a congestion is still present or not. Further the corresponding percentage values could be regularly reported or forwarded to the Policy and Charging Rule Function PCRF. The P-GW, the GGSN or the Policy and Charging Rule Function PCRF compares the percentage value, detects if there is a congestion present in the mobile network and initiates if applicable corresponding congestion avoidance actions.

According to a further preferred embodiment congestion detection rules for determining congestion are provided, preferably by the congestion avoidance policy control function to the action function. This further enhances the flexibility, so that not only congestion avoidance policies can be dynamically imposed but also the determination of a congestion.

According to a further preferred embodiment the congestion avoidance actions are locally and/or statically configured. This enables user plane entities or nodes to decide or select which traffic engineering policy to be used and/or the data traffic, bearer or the like for which they should be applied without dynamical interaction with other network nodes in the control plane of the mobile communication network like the Policy and Charging Rule Function PCRF.

There are several ways how to design and further develop the teaching of the present invention in an advantageous way. To this end it is to be referred to the patent claims subordinate to patent claim 1 on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will we explained. In the drawing

FIG. 1 shows a schematic view of a conventional method;

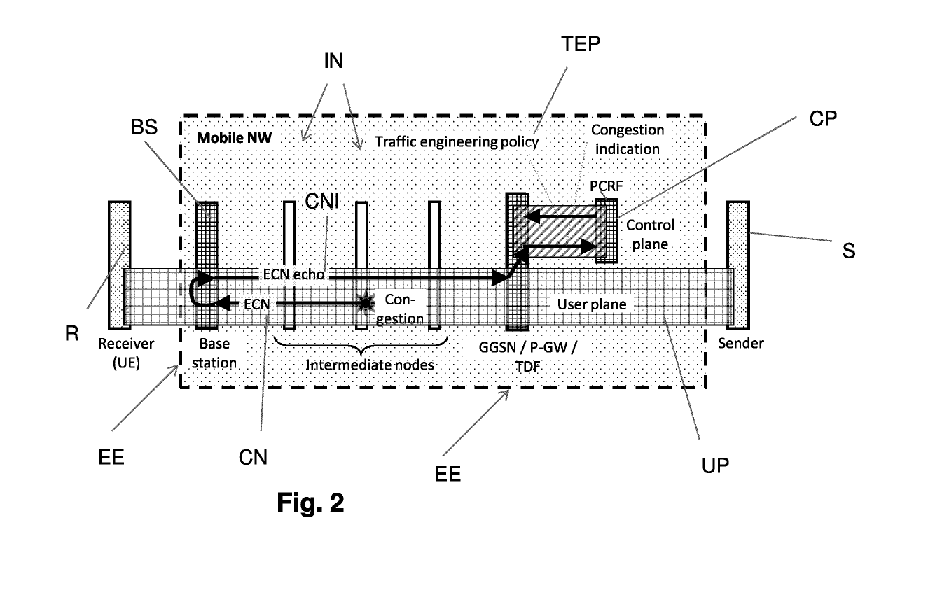

FIG. 2 shows a schematic view of a method according to a first embodiment of the present invention;

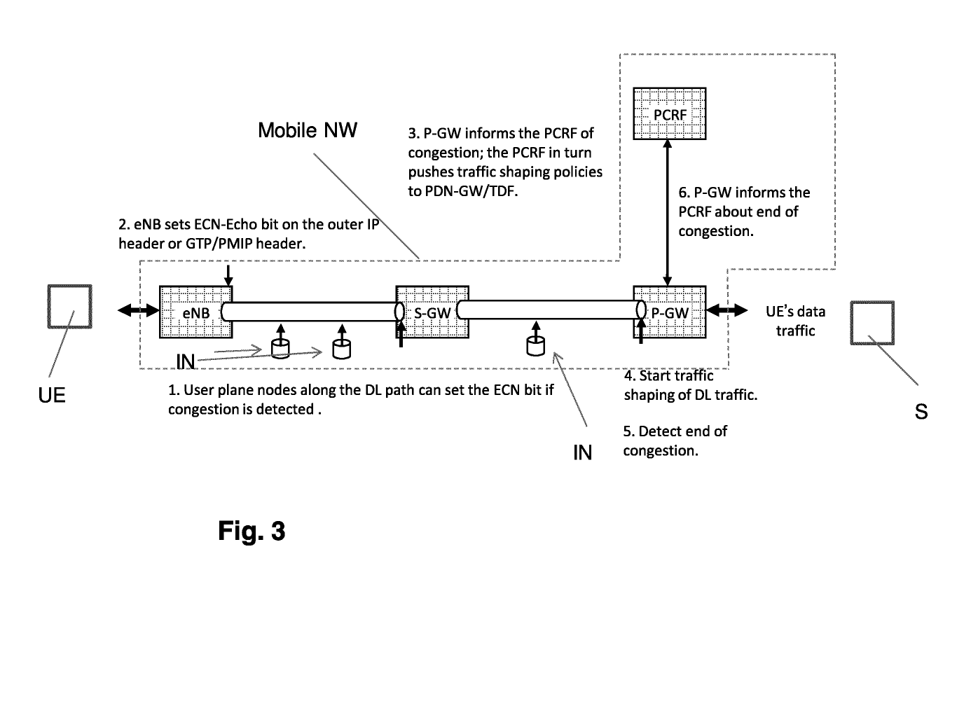

FIG. 3 shows a schematic view of a method and a system according to a second embodiment of the present invention;

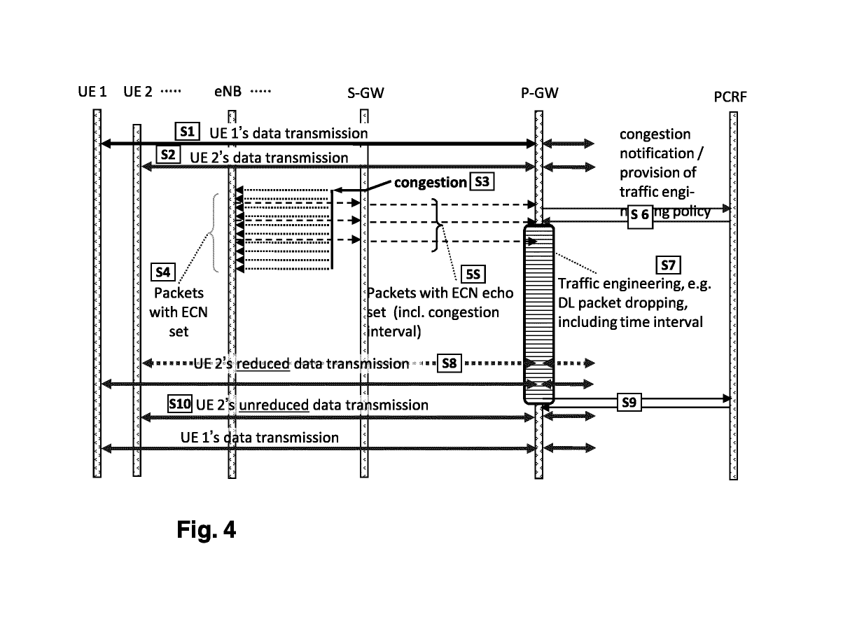

FIG. 4 shows a schematic view of a method according to a third embodiment of the present invention;

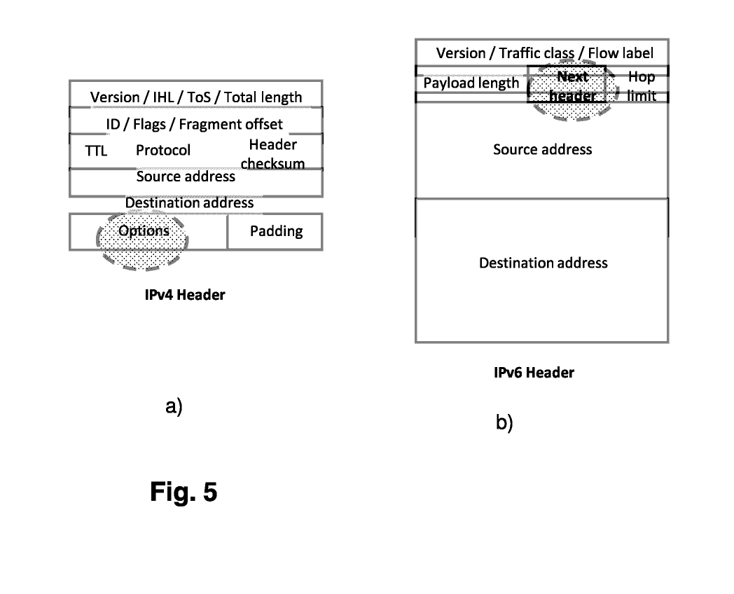

FIG. 5 shows congestion notification information included in headers according to a fourth embodiment of the present invention;

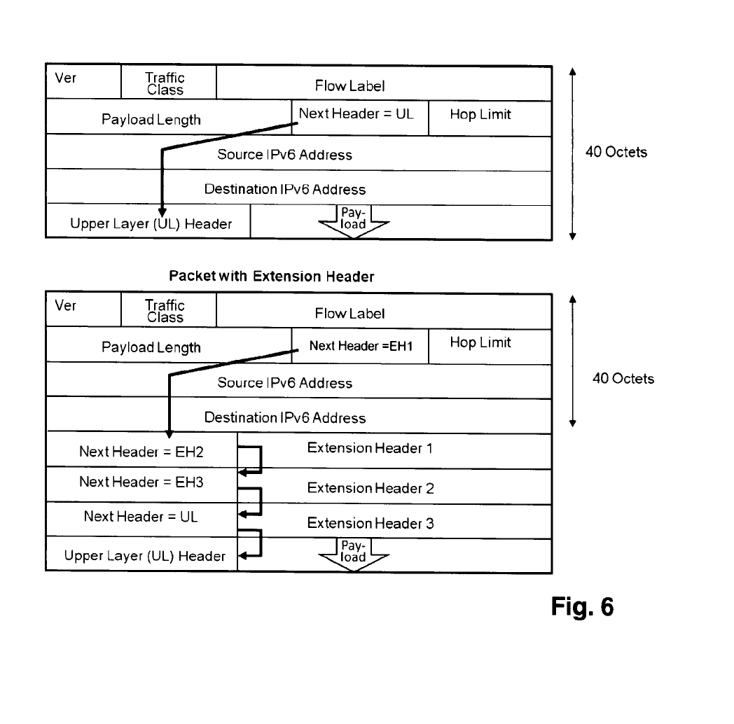

FIG. 6 shows congestion notification information included in headers according to a fifth embodiment of the present invention;

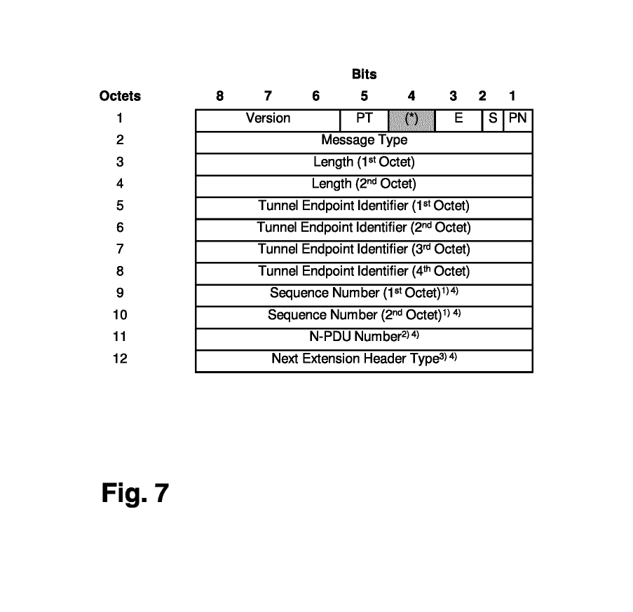

FIG. 7 shows congestion notification information included in headers according to a sixth embodiment of the present invention;

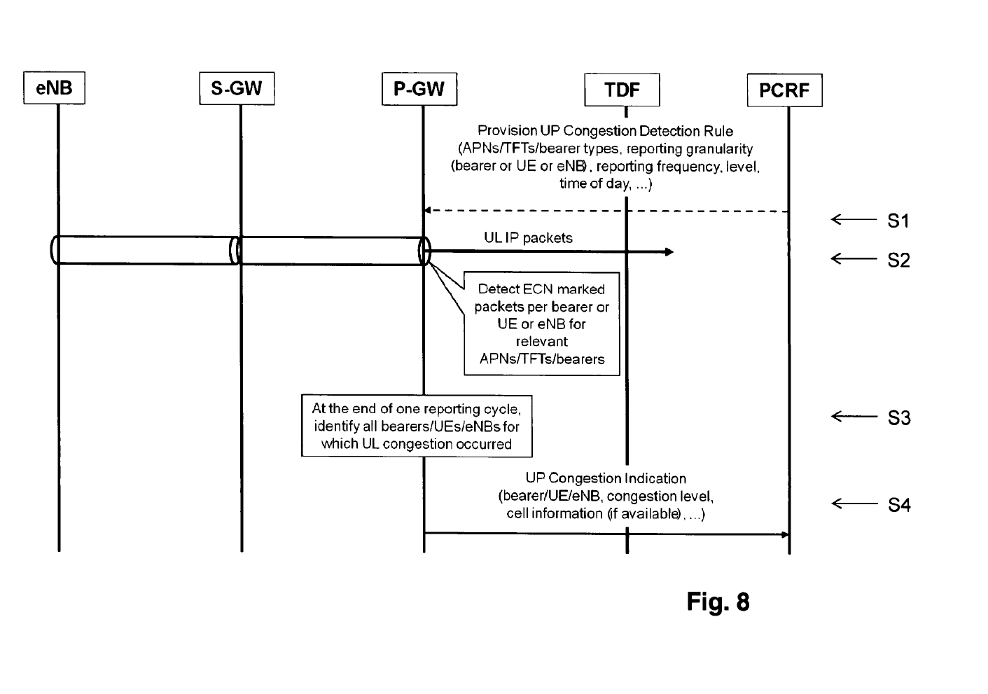

FIG. 8 shows a schematic view of a method according to a seventh embodiment of the present invention;

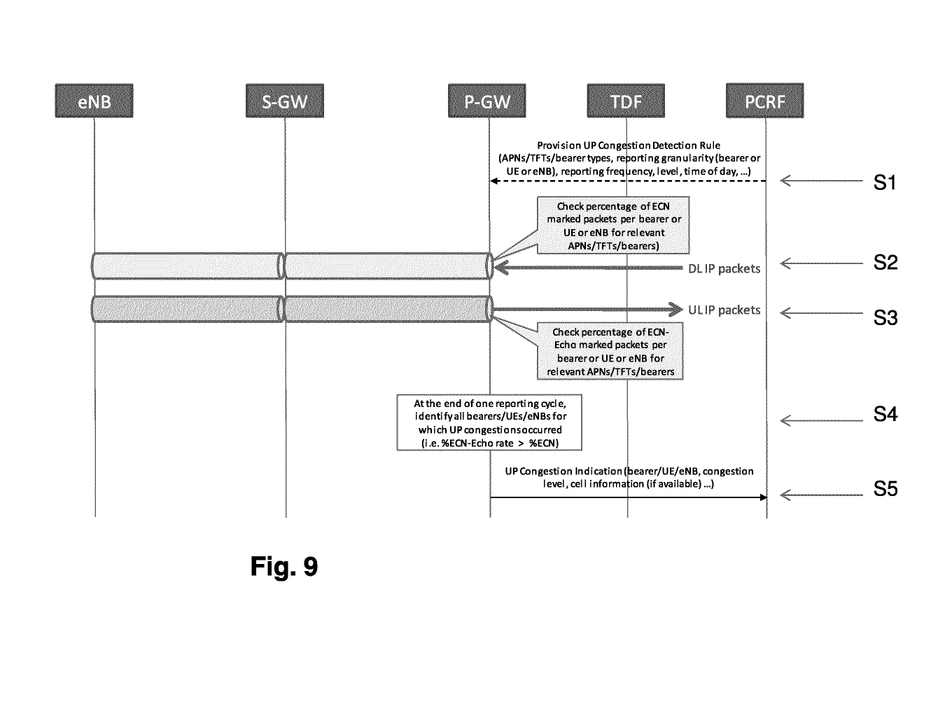

FIG. 9 shows a schematic view of a method according to an eighth embodiment of the present invention;

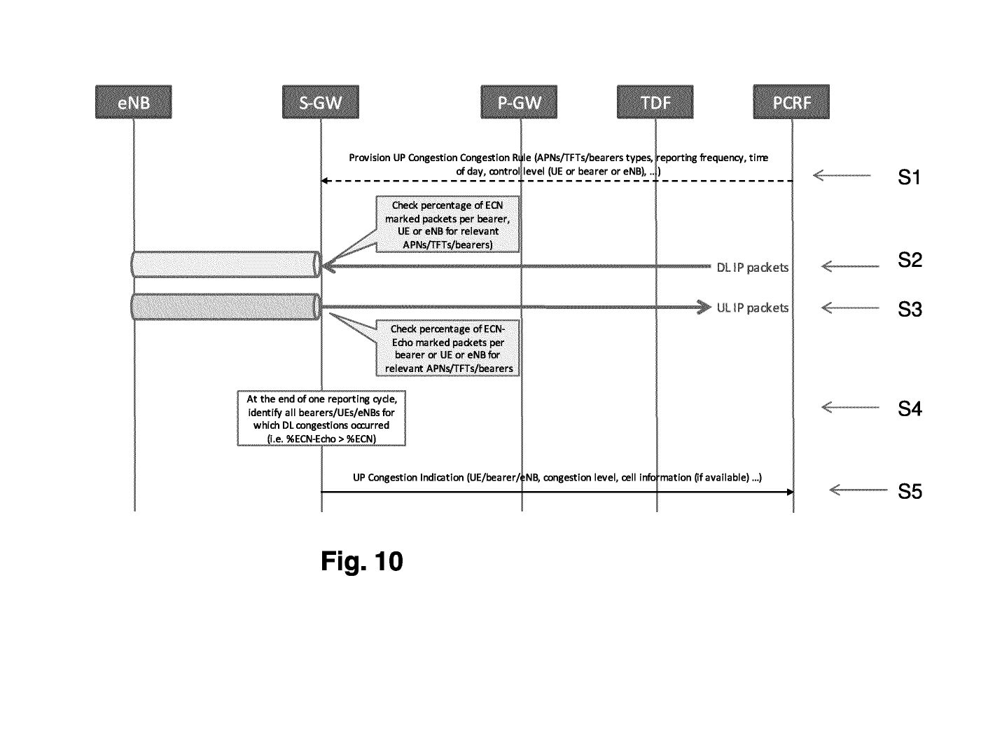

FIG. 10 shows a schematic view of a method according to a ninth embodiment of the present invention; and

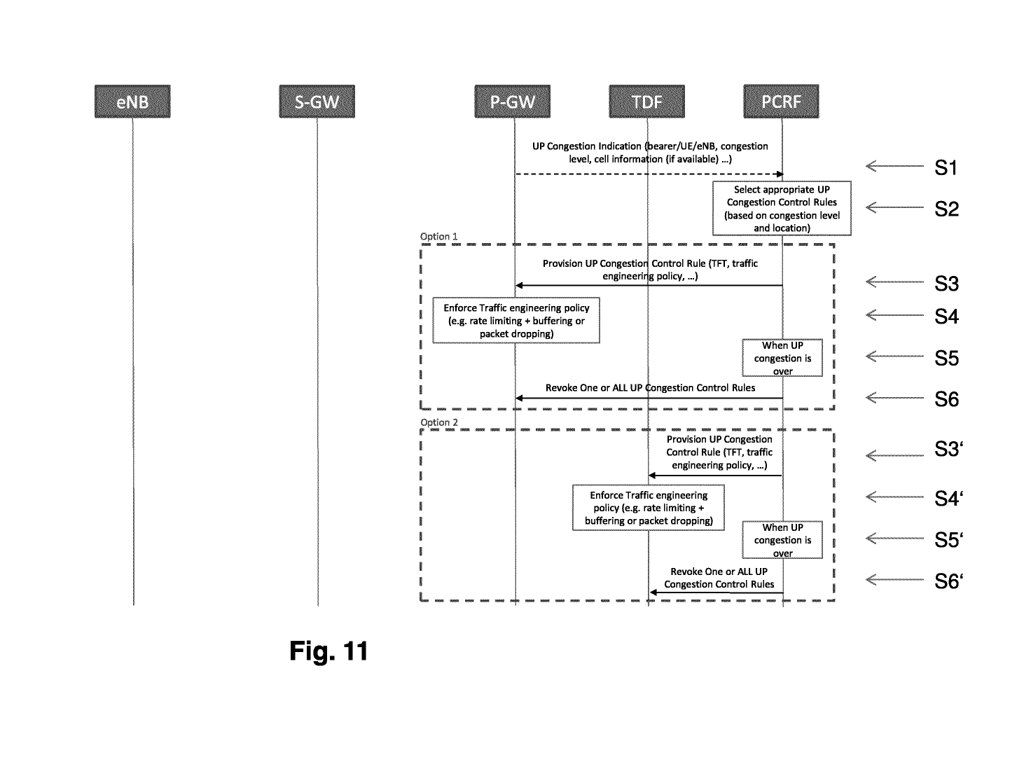

FIG. 11 shows a schematic view of a method according to a tenth embodiment of the present invention.

FIG. 1 shows a schematic view of a conventional method.

In FIG. 1 a conventional overall scheme of ECN and related signaling is shown. A sender S and a receiver R are connected via intermediate nodes IN in a user plane UP and a control plane CP. When the congestion C occurs in one of the intermediate nodes IN, the corresponding intermediate node IN sets an ECN indication in an IP header of packets in the user plane UP upon congestion. ECN indication is signaled then in direction to the data sink, i.e. the receiver. The receiver R will then upon receipt of the ECN indication either try to downgrade the sending rate, for example by renegotiating the media codec in case of voice or multimedia communication, through application-level control signaling or signal to the sender S via transport protocol signaling that the network is congested, for example in TCP acknowledgements according to IETF RFC 5562. The sender S may then reduce the sending rate which may overcome the network congestion. The receiver R signals therefore any congestion related signaling CNI in the control plane CP back to the senders to that the senders could initiate congestion avoidance actions. As an example the sender S may be a server in the internet and the receiver R may be a mobile terminal, for example a user equipment UE.

FIG. 2 shows a schematic view of a method according to a first embodiment of the present invention.

In FIG. 2 the mobile network comprises a base station BS, a plurality of intermediate nodes IN, and a gateway GPRS support node GGSN, a packet data network gateway P-GW or a traffic detection function TDF. A sender S is connected on the user plane UP via the GGSN/P-GW/TDF and intermediate nodes IN and further via the base station BS with a receiver R in form of a user equipment UE. The base station BS and the gateway GPRS support node GGSN/packet data network gateway P-GW/traffic detection function TDF are edge entities EE of the mobile network. Edge entities EE are in general gateways, e.g. GGSN, P-GW or TDF, for downlink traffic or base station BS, e.g. node B or evolved node B for uplink traffic so that they can limit the traffic entering or leaving the mobile network at the mobile network border. The term base station is to be understood generic and for example in UMTS the term base station means node B, in LTE the term base station refers to an evolved node B eNB or a relay node RN and in WIMAX the term base station as well as in GPRS means base station in the sense of GPRS and WIMAX.

In FIG. 2 the base station, for example a node B NB or an evolved node B eNB provides feedback to the GGSN/P-GW/TDF upon receipt of an ECN indication so that the GGSN/P-GW/TDF may limit and/or shape the downlink traffic from the sender S to the receiver R in case congestion already occurs or is about to occur within the mobile network. This enables the GGSN/P-GW/TDF to enforce locally configured traffic engineering policies, for example traffic shaping, rate limiting, etc.

In more detail, if a congestion occurs at an intermediate node IN, the intermediate node includes an ECN indication as a congestion notification in the download data traffic to the receiver R. The base station BS as edge entity EE of the mobile network N in the downlink direction includes then an ECN-echo indication as congestion notification information CNI in a correspondent uplink packet for each ECN indication detected on a downlink data packet. This enables the GGSN/P-GW/TDF to detect whether or not a congestion occurred within the mobile network or outside. For example if a counter for downlink ECN indications as congestion notification for a particular bearer, a particular user equipment or particular base station BS is lower than a corresponding counter for uplink ECN echo indications as congestion notification information for that bearer, user equipment or base station BS this indicates that a congestion occurred within the mobile network. Otherwise the congestion already occurred outside the mobile network.

A further base station BS may also provide information about a cell of the base station BS, for example a corresponding cell ID, a location area, routing area, tracking area, closed subscriber group, EPS cell global ID or the like. This information may be used by the GGSN/P-GW/TDF and/or a policy and charging rule function PCRF to which the GGSN/P-GW/TDF is connected in the control plane CP to apply traffic engineering policies TEP also to downlink traffic of other user equipment located within the cell of the base station or that are associated to the location area, routing area, tracking area, closed subscriber group or EPS cell global ID ECGI. These additional information items are optional. Even if these information items are not applicable, for example the policy and charging rule function PCRF may enforce traffic engineering policies TEP to any of the IP flows, bearers or any data transmission connection between the receiver R and the sender S.

The GGSN/P-GW/TDF informs the Policy and Charging Rule Function PCRF in the control plane CP about the detected congestion in the downlink traffic at one of the intermediate nodes IN. The policy and charging rule function PCRF then provides traffic engineering policies TEP to the GGSN, P-GW and/or TDF as congestion avoidance policy in order to reduce the congestion in the mobile network. The GGSN/P-GW/TDF which obtains the traffic engineering policies TEP will then enforce those traffic engineering policies TEP in the user plane UP between sender S and receiver R.

These traffic engineering policies TEP may comprise a set of traffic flow templates TFT to identify the traffic flows to which the traffic engineering policies should apply and additionally one or more of the following actions:
Rate limiting/traffic shaping
Extended buffering with intelligent scheduling (to achieve fairness among UEs/flows and/or account for user/traffic priorities and account application requirements)
Intelligent packet dropping (e.g. drop certain types of frames—e.g. low-priority video frames)
Trigger handover of IP flows to another access (if available)
Change (AMR) codec value (on behalf of the UE)
Redirect traffic to a dedicated node (e.g. media gateway or compressor).

These traffic engineering policies TEP may be mapped to conventional quality of service QoS policies. These policies may also be implemented by extending conventional quality of service policy frameworks.

FIG. 3 shows a schematic view of a method and a system according to a second embodiment of the present invention.

In FIG. 3 an overall scheme based on LTE/EPC architecture and for downlink direction is illustrated for congestion in the user plane UP.

In FIG. 3 a user equipment UE is connected to an evolve node B eNB which is further connected via intermediate nodes IN to a serving gateway S-GW. The serving gateway S-GW is connected via a further intermediate node IN to the packet data network gateway P-GW. The packet data network gateway P-GW is connected to a policy and charging rule function PCRF. Further the packet data network gateway P-GW is connected to a sender S, for example a server in the internet for conveying user equipment's data traffic from the server S via itself, the serving gateway S-GW the evolved node B eNB and intermediate nodes IN to the user equipment UE.

The mobile network comprises therefore the evolved node B eNB, the intermediate nodes IN, the serving gateway S-GW, the packet data network gateway P-GW and the policy and charging rule function PCRF.

User plane nodes, i.e. the evolved node B eNB, the intermediate nodes IN, the serving gateway S-GW, and the packet data network gateway P-GW along the downlink path from the sender S to the user equipment UE set the ECN bit in a first step 1 if a congestion occurs according to conventional methods. Besides transport/backhaul network routers or switches, the packet data network gateway P-GW, the serving gateway S-GW and/or the evolved node B eNB may also set the corresponding ECN bit.

Upon receipt of data packets marked with an ECN bit or if a downlink congestion is detected or present at the evolved node B eNB, the evolved node B eNB sets the ECN-echo bit in a corresponding uplink data packet in a second step 2, for example in the outer IP header or the GTP header that either belongs to the uplink bearer corresponding to the downlink bearer or that is transmitted to the same packet data network gateway P-GW. In case of GPRS/EPC traffic, traffic is based on GTP/PMIP bearers/tunnels the ECM echo indication and optionally further information like relevant cell information, for example cell ID/IP the ECN-echo indication is included into the bearers and/or tunnel's outer IP header, i.e. extension header or into the GTP header at the corresponding granularity level of bearers, user equipment or base stations respectively cells.

Upon receipt of the ECN-echo indication a P-GW/TDF will in a third step 3 then inform the Policy and Charging Rule Function PCRF of the detected congestion in the mobile network/backhaul network/radio access network. The P-GW/TDF may then report all available information, for example cell ID, bearer ID, access time, etc. to the Policy and Charging Rule Function PCRF so that the Policy and Charging Rule Function PCRF has sufficient information to decide which congestion avoidance action(s) is/are initiated. The PCRF will then provide traffic engineering policies TEP and/or extended quality of service policies to the packet data network gateway P-GW/TDF. One of the examples for a traffic engineering policy TEP is a traffic flow template to identify flows plus bucket size for traffic shaping. The Policy and Charging Rule Function PCRF does not necessarily only provide traffic engineering policy TEP for bearers for which user plane congestion has be detected. The policy and charging rule function PCRF may further limit other, for example low priority, bearers that share the same core network, backhaul access or radio access links as the congested bearer. Thus flexibility is enhanced and congestion avoidance is optimized.

In a fourth step 4 the packet data network gateway P-GW/traffic detection function TDF starts congestion counter measures or congestion avoidance actions by enforcing the traffic engineering policies TEP like traffic shaping policies, for example through extended buffering, intelligent packet dropping or the like.

In a fifth step 5 if the end of congestion is detected at the packet data network gateway P-GW, mentioned further downward in the description, e.g. based on ECN counter, absence of congestion indication in GTP echo messages or congestion end time reached, the packet data network gateway P-GW/TDF may either stop autonomously the congestion counter measures or congestion avoidance actions of the previous step 4 or may alternatively inform the Policy and Charging Rule Function PCRF about an end of congestion.

When the packet data network gateway P-GW/TDF reports in a sixth step 6 an end of a congestion to the Policy and Charging Rule Function PCRF, it may decide either to update the traffic engineering polices TEP, for example a throttling rate, or revoke them, i.e. all of the above mentioned congestion counter measures or congestion avoidance actions can be made obsolete.

FIG. 4 shows a schematic view of a method according to a third embodiment of the present invention.

In FIG. 4 a principle scheme of user plane downlink congestion for EPC between a packet data network gateway P-GW and a serving gateway S-GW on a time axis is shown. In FIG. 4 two user equipment UE1, UE2 are shown which are connected via an evolved node B eNB and further intermediate entities (not shown in FIG. 4) to a serving gateway S-GW which is further connected to a packet data network P-GW. The packet data network gateway P-GW is, as already depicted in FIG. 3, connected to a Policy and Charging Rule Function PCRF. The first and second user equipment UE1, UE2 exchange data via the evolved node B eNB, the serving gateway S-GW and the packet data network gateway P-GW with a sender, for example a server in the internet (not shown in FIG. 4). This is denoted with reference signs S1 and S2 in FIG. 4.

If a congestion is detected in the serving gateway S-GW, denoted with reference sign S3, the ECN bit is set within data packets in downlink direction to the user equipment UE1, UE2. Upon receipt of the data packets marked with ECN the evolved node B eNB sets ECN-echo indications in a fifth step S5 in corresponding upload data packets included congestion interval to the packet data network gateway P-GW. As an edge entity EE the packet data network gateway P-GW provides in a sixth step S6 congestion notification information to the Policy and Charging Rule Function PCRF which in turn provides traffic engineering policies TEP back to the packet data network P-GW.

In a seventh step S7 the packet data network gateway P-GW enforces this traffic engineering policies provided by the Policy and Charging Rule Function PCRF, for example download packets are dropped in certain time intervals. This reduces the data transmission of the second user equipment UE2 and the data transmission of the first user equipment UE1 is unaffected (reference sign S8). This is an example for selectively applying traffic engineering policies TEP to certain user equipment.

If in a ninth step S9 an end of the congestion is detected the packet data network gateway P-GW informs the Policy and Charging Rule Function PCRF about the end of the congestion and the Policy and Charging Rule Function PCRF replies by revoking the corresponding traffic engineering policies TEP for the second user equipment UE2. In a tenth step S10 the data transmission from and/or to the second user equipment UE2 is then again unreduced.

In FIG. 4 it is assumed that a downlink congestion between the serving gateway S-GW and the involved node B eNB is present and a congestion time interval is provided by the evolved node B eNB to the packet data network gateway P-GW. Further it is assumed that traffic engineering policies TEP are revoked exclusively by the Policy in Charging Rule Function PCRF. It is even further assumed that the traffic engineering policies TEP apply only for the second user equipment and leave the first user equipment UE1 respectively its data traffic unaffected, for example because of better or prioriterized subscription properties.

The principle scheme according to FIGS. 3 and 4 is not limited to downlink traffic only but may also be adopted for uplink user plane congestion: In this case the packet data gateway P-GW/traffic detection function TDF would set upon detection of the ECN bit in data packets the ECN-echo indication in corresponding downlink user plane data packets to inform the evolved node B eNB as edge entity about uplink congestion in the user plane UP. The evolved node B eNB would then intern apply either locally configured traffic shaping or engineering policies TEP or traffic shaping/engineering policies TEP that are provisioned by the Policy and Charging Rule Function PCRF in conjunction with the ECN-echo indication to the evolved node B eNB.

Further, the principle scheme according to FIGS. 3 and 4 is also applicable for relay scenarios: In this case a donor evolve node B DeNB may also set the ECN bit when there is a downlink congestion on the radio interface between the donor evolve node B DeNB and the relay evolved node B eNB. Further in this case the donor evolved node B DeNB or the relay node B eNB may send the ECN-echo indication upstream towards the packet data network gateway P-GW/traffic detection function TDF/serving gateway S-GW.

FIG. 5 shows congestion notification information included in headers according to a fourth embodiment of the present invention.

In FIGS. 5a and 5b IPv4 and IPv6 packet formats as options for coding ECN-echo messages are shown. In case of the downlink congestion detection between a base station and the GGSN/P-GW/TDF or for uplink congestion detection in the reverse direction accordingly the ECN-echo indication is signaled between the aforementioned entities in the mobile network. Further cell related information for example cell ID or IP address of a base station or location area, routing area, tracking area, close subscriber group, EPS cell global ID information or the like may be also signaled to the GGSN/P-GW/TDF together with the ECN-echo indication. This additional information may be used by the GGSN/P-GW/TDF and/or the Policy and Charging Rule Function PCRF to apply traffic engineering policies TEP also to downlink traffic of other user equipment served by a corresponding cell or the like.

In the case the Policy and Charging Rule Function PCRF is already aware of user equipment serving cells the Policy and Charging Rule Function PCRF may also enforce traffic engineering policies TEP for other user equipment that are serviced by the cell which indicated user plane congestion or by other cells belonging to the same location area, routing area, tracking area, close subscriber group, EPS cell global ID or the like. In another case the evolved packet core EPC may also be configured to notify a USER_LOCATION_CHANGE to the Policy and Charging Rule Function PCRF, for example upon a change of a closed subscriber group or the EPS cell global ID. This additional information may then be used by the PCRF to enforce corresponding traffic engineering policies TEP to the user equipment with changed location. The cell related information may also be provided as part of a bearer setup or mobility signaling. For example the serving gateway S-GW may provide the cell ID or other information also to the packet data network gateway P-GW during bearer setup, i.e. “create session request” or during mobility signaling, i.e. “modify bearer request”.

The ECN-echo indication and possibly additional information as mentioned above such as the cell ID or the IP address of the base station may be signaled in the following ways: According to FIG. 5a a new IPv4 option in the IPv4 header may be created to carry the ECN-echo indication and/or ECN bit and further as an option additional information like cell related information.

In FIG. 5b a corresponding extension header for IPv6 of the outer IP header for GTP/PMIP bearer/tunnel is shown. A new IPv6 extension header, for example a router header or a hop-by-hop header to carry the ECN-echo indication and/or ECN bit and optionally additional information like cell information is described.

FIG. 6 shows congestion notification information included in headers according to a fifth embodiment of the present invention.

In FIG. 6 in detail a new IPv6 extension header to carry the ECN-echo indication and/or the ECN bit plus optionally additional information like cell information is shown. In FIG. 6 the ECN-echo indication is coded as “next header” according to IPv6.

FIG. 7 shows congestion notification information included in headers according to a sixth embodiment of the present invention.

In FIG. 7 options for coding a ECN-echo indication in a GTP header and extension header is shown. FIG. 7 shows therefore a conventional GTP-U header structure with a new GTP-U header field. This may be implemented by using a spare bit in form of bit number 4 of the first octet, to carry the ECN-echo indication and/or the ECN bit and additionally a GTP-U extension header for additional information like cell related information.

The ECN-echo indication may be provided in form of a single bit implying that if the ECN-echo indication bit is set, the receiver of this indication would know that the congestion occurred on the user plane path in the other direction. Alternatively, the ECN-echo indication may also be provided in form of two bits where one bit is used to indicate that the ECN/ECN-echo indication is supported by the sender and the second bit may then indicate whether or not a congestion is occurred.

The ECN-echo indication may be further extended to allow for explicit signaling of congestion start/begin and congestion stop/end periods. In this case the ECN-echo indication would then only have to be piggybacked when there is a change of congestion situation detected in the user plane transmission path.

Alternatively, instead of piggybacking the ECN-echo congestion indication on the user plane data traffic the congestion indication between the mobile network entities, for example the evolved node B eNB or the serving gateway S-GW the packet data network P-GW may also be signaled by piggybacking a new congestion indicator onto existing GTP-echo messages that are exchanged between mobile network entities. In this case the GTP-echo messages are extended by the congestion notification information which may be provided in two forms, namely a congestion indication or a congestion start/begin and congestion stop/end indication.

In the first case the mobile network entity detecting the congestion, i.e. based on the ECN indications includes the congestion indication in each GTP-echo message towards the GTP node from which ECN indications were received; the absence of such ECN indications are interpreted by the receiving GTP node that the congestion period is now over, i.e. the congestion has vanished.

In the second case beginning and end of the congestion period are explicitly signaled. Intermediary GTP nodes, for example a serving gateway S-GW in case of an evolved packet system bounces or reflects a congestion indication received as part of the GTP-echo message towards the GTP entity terminating the end-to-end GTP tunnel, for example the packet data network gateway P-GW in case of downlink congestion or the evolved node B eNB in case of uplink congestion. The new congestion indicator could further indicate in addition to the congestion indication also information about the mobile network entity which has detected the congestion, for example cell ID, cell IP address or packet data network gateway P-GW, IP address or the like. This information enables to clarify on which GTP path the congestion occurred and can be used, for example by the Policy and Charging Rule Function PCRF to further optimize mitigation of the congestion. For example in this case an intermediary GTP node reflects this information towards the GTP entity terminating the end-to-end GTP tunnel, i.e. the packet data network gateway P-GW in case of a downlink congestion or the evolved node B eNB in case of an uplink congestion. Bulk signaling techniques may be applied to signal for example multiple congestion indications from different evolved node Bs eNBs towards the packet data network gateway P-GW. A restriction of a minimum time between GTP-echo messages, for example 60 seconds may not necessarily applied. The same extension as to the GTP-U header structure may also be applied to PMIP Heartbeat messages according to 3GPP TS 29.275 for the case that Gxx is not used for congestion notification handling and subsequent traffic engineering policies TEP to and/or from the Policy and Charging Rule Function PCRF.

FIG. 8 shows a schematic view of a method according to a seventh embodiment of the present invention.

In FIG. 8 uplink congestion detection in the packet data network gateway P-GW is shown. In order to activate user plane congestion control the Policy and Charging

Rule Function PCRF may provision the user plane congestion detection rule to the packet data network gateway P-GW/traffic detection function TDF. The PCRF may define the scope of the congestion detection rule, for example the access point names APNs for which the congestion detection rule should be applied, the bearer types, for example only for default bearers or non-GPRS bearers, the traffic type via traffic flow templates TFT, a maximum frequency within which the packet data network gateway P-GW/traffic detection function TDF should report a user plane congestion, the granularity level upon which a congestion should be reported, for example low, medium or high, at which granularity the reporting should take place, for example on a user equipment basis, a bearer basis or a cell basis and/or activation time, i.e. at what time of the day the rule should be active.

User plane congestion detection rules may provide the information for both uplink and downlink congestion detection or alternatively a single rule is either for uplink or downlink direction, i.e. that the Policy and Charging Rule Function PCRF would provision among separate rule for each direction. Once a user plane congestion detection rule is active the packet data network gateway P-GW/traffic detection function TDF starts detecting uplink or downlink congestion. In FIG. 8 the case for uplink congestion is shown: In a first step S1 the packet data network gateway P-GW/traffic detection function TDF provides user plane congestion detection rules, for example as mentioned above to the Policy and Charging Rule Function PCRF. In a second step S2 the packet data network gateway P-GW/traffic detection function TDF counts uplink packets that have the ECN bit set on a per user equipment, bearer or cell basis. When the number or frequency of ECN marked packets is significant depending on the granularity level in a third step S3, the packet data network gateway P-GW/traffic detection function TDF provides a user plane congestion indication to the Policy and Charging Rule Function PCRF to inform it about the uplink congestion level in a fourth step S4.

To avoid that the Policy and Charging Rule Function PCRF is flooded with congestion indications the user plane congestion detection rule may define a maximum frequency for such congestion indications. In case the P-GW/TDF detects several user equipment, bearers and/or cells for which congestion has occurred during a predefined reporting period the P-GW/TDF may send a list of all user equipment, bearers and/or cells that are congested in bulk to the Policy and Charging Rule Function PCRF.

FIG. 9 shows a schematic view of a method according to an eighth embodiment of the present invention.

In FIG. 9 a downlink congestion detection in the packet data network gateway P-GW similar to FIG. 8 is shown. In a first step S1 the Policy and Charging Rule

Function PCRF provides user plane congestion detection rules to the P-GW/TDF, for example APNs/TFTs/bearer types reporting granularity (bearer or user equipment or evolved node B eNB), reporting frequency, level and/or time of day or the like. In a second step S2 the P-GW/TDF send a percentage of ECN bit marked data packets per bearer per user equipment or per evolved node B eNB for relevant APNs/TFTs/bearers on downlink IP packets. In a third step S3 the packet data network gateway P-GW/traffic detection function TDF checks the percentage of ECN-echo marked data packets per bearer, per user or per evolved node B eNB for relevant APNs/TFTs/bearers. In a fourth step S4 at the end of predefined reporting period or cycle all bearers/user equipment/evolved node Bs eNBs for which user plane congestion occurred is identified, for example the percentage of ECN-echo is greater than the percentage of ECN marked packets. In a fifth step S5 the P-GW/TDF indicates to the Policy and Charging Rule Function a user plane congestion including bearer/user equipment/evolved node B, congestion level, cell information if available or the like.

In summary in FIG. 9 the packet network data gateway P-GW or the traffic detection function TDF counts packets that have the ECN indication bit set in the downlink direction and the ECN-echo indication set in the uplink direction on a per bearer, per user equipment or per cell basis. When the percentage of packets with ECN-echo indication set is significantly higher depending on the granularity level and depending on a pre-given threshold than the percentage of packets with ECN indication set the packet data network gateway P-GW or the traffic detection function TDF provides a user plane congestion indication to the Policy and Charging Rule Function PCRF to inform it about the downlink congestion level.

FIG. 10 shows a schematic view of a method according to a ninth embodiment of the present invention.

In FIG. 10 a downlink congestion detection in the serving gateway S-GW for a PMIP based S5/S8 interface is shown.

As an alternative to FIG. 9 the packet data network gateway P-GW and the traffic detection function TDF in FIG. 10 may also be instructed to report on a regular basis percentages of ECN-echo and ECN marked packets. The Policy and Charging Rule Function PCRF compares then these values and detects if there is a user plane congestion in the mobile network. For evolved packet core EPC with PMIP base S5/S8 interface the user plane congestion detection rule may also be provided via the Gxx interface between the PCRF and the S-GW. In that case the serving gateway S-GW, for example BBERF, may then process the user plane congestion detection and provide the congestion indication upon congestion detection to the Policy and Charging Rule Function PCRF: In a first step S1 the Policy and Charging Rule Function provides user plane congestion rules (APNs/TFTs/bearer types, reporting frequency, time of day, control level (user equipment, bearer and/or evolved node B or the like)) to the serving gateway S-GW. In a second step S2 the serving gateway S-GW checks a percentage of ECN marked packet per bearer, per user equipment or per evolved Node B for relevant APSs/TFTs/bearers in downlink IP packets. In a third step S3 the serving gateway S-GW checks a percentage of ECN-echo marked packages per bearer, per user equipment or per evolved node B for relevant APNs/TFTs/bearers. In a fourth step S4 the serving gateway S-GW identifies at the end of one predefined reporting period or a cycle all bearers/user equipments/evolved node Bs for which a downlink congestion occurred, preferably in case if the percentage of ECN-echo market packages is greater than the percentage of ECN marked packages. In a fifth step S5 the serving gateway S-GW indicates a user plane congestion indication to the Policy and Charging Rule Function PCRF including bearer/user equipment/evolved node B information, congestion level, cell information if available, etc.

The Policy and Charging Rule Function PCRF may detect that a user plane congestion for a given user equipment, bearer or cell has finished when at the end of the predefined reporting period or cycle the further user plane congestion indication is provided or sent to the Policy and Charging Rule Function PCRF.

Alternatively the packet data network gateway P-GW or the traffic detection function TDF detecting the user plane congestion may also send a user plane congestion indication start message once it detects the congestion first and sends an explicit user plane congestion indication stop message when the congestion is over.

In case of a downlink user plane congestion the P-GW/TDF may detect that the user plane congestion is over when
1. the percentage of ECN-echo indications received by the P-GW/TDF in the uplink is again equal to or only a little higher depending on the granularity level than the percentage of ECN indications seen in the corresponding downlink over a defined evaluation interval. Then the congestion period for that user equipment can considered to be over or in case
2. the downlink congestion is indicated via a GTP-echo message, the congestion period is then considered to be over as a GTP-echo message has been received without the congestion indication or an explicit congestion stop/end indication.

In case of an uplink user plane congestion the base station, for example an evolved node B, a node B or the like may detect that the user plane congestion is over when
1. a percentage of packets with ECN-echo indication is back to zero or only a little higher depending on the granularity level over the predefined evaluation time interval. Then the congestion period for that user equipment can be considered to be over or in case
2. the uplink congestion is indicated via a GTP-echo message, then a congestion period is considered to be over as soon as a GTP-echo message has been received without the congestion indication or an explicit congestion stop/end indication.

The P-GW/TDF may detect that the user plane congestion is over when the percentage of packets with ECN indication is back to zero or only a little higher, depending on the granularity level, over the predefined evaluation time interval.

FIG. 11 shows a schematic view of a method according to a tenth embodiment of the present invention.

In FIG. 11 provisioning and enforcement of user plane congestion control rules respectively the corresponding information flow is shown in FIG. 11.

In a first step S1 the packet data network gateway P-GW informs the Policy and Charging Rule Function PCRF about the user plane congestion by a user plane congestion indication accompanied with bearer/user equipment/evolved node B information, congestion level, cell information if available or the like. The Policy and Charging Rule Function PCRF then selects in a second step S2 appropriate user plane congestion control rules preferably based on congestion level and location. In a third step S3 the Policy and Charging Rule Function PCRF then provides corresponding user plane congestion control rules (TFT, traffic engineering policies, etc.) back to the packet data network gateway P-GW. In a fourth step S4 the packet data network gateway P-GW enforces then the corresponding provided traffic engineering policies TEP, for example limits the transmission rates, performs buffering and/or intelligent packet dropping. In a fifth step S5 when the Policy and Charging Rule Function PCRF determines that a user plane congestion is over then the Policy and Charging Rule Function PCRF revokes one or all user plane congestion control rules in a sixth step S6 by sending corresponding commands to the packet data network gateway P-GW.

Alternatively, the steps S3-S6 may be performed instead between the packet data network gateway P-GW and the Policy and Charging Rule Function PCRF between the traffic detection function TDF and the Policy Charging Rule Function PCRF denoted with reference signs S3′, S4′, S5′ and S6′. These steps S3′-S6′ correspond to the steps as S3-S6.

In summary once the Policy and Charging Rule Function is informed about user plane congestion the Policy and Charging Rule Function PCRF will select or derive appropriate user plane congestion control rules and provide them to the relevant packet data network gateway P-GW and/or traffic detection function TDF.

These control rules can be for uplink and downlink congestion control at the P-GW and/or the TDF. Alternatively or additionally uplink congestion control rules can be either enforced at the P-GW and/or the TDF but may also be transported via control plane signaling towards a base station, for example in FIG. 11 in form of an evolved node B eNB, for example via GTP-c and S1AP or towards a user equipment so that those entities, i.e. the base station and/or the user equipment can mitigate uplink congestion already at the sender or at least close to the sender.

The Policy and Charging Rule Function PCRF is not limited to provide congestion control rules only for the user equipment, bearer or cell for which the congestion has been indicated. The Policy and Charging Rule Function PCRF may take decisions on which uplink data traffic, i.e. bearer or the like to control and flexibly define, based on traffic flow templates TFT, to which data traffic the congestion control rule should be applied. The Policy and Charging Rule Function PCRF may also choose from a set of traffic engineering policies TEP that are supported by the packet data network gateway P-GW and/or the traffic detection function TDF. This is shown in FIG. 11 by the steps S1-S6 respectively S1-S2, S3′-S6′.

In FIG. 11 it is assumed that the Policy and Charging Rule Function PCRF is preconfigured with capabilities of the packet data network gateway-GW/traffic detection function TDF with respect to traffic engineering. The P-GW and/or the TDF receiving the congestion control rule will then enforce the traffic engineering policy or policies TEP for all data traffic that matches the traffic flow template(s) TFT.

Once the Policy and Charging Rule Function PCRF detects that there is no more user plane congestion it will revoke the user plane congestion control rules either gradually, for example based on internal logic, for example starting with restrictions set for high-priority subscribers or data traffic, or all-at-once. For an evolved packet core EPC with PMIP based S5/S8 interface the user plane congestion control rules may also be provided to the serving gateway S-GW via Gxx interface between the Policy Charging Rule Function PCRF and the serving gateway S-GW. Then the serving gateway S-GW, for example BBERF then enforces the traffic engineering policies TEP. In roaming scenarios an interaction between the S-GW/P-GW/TDF and visited or home Policy and Charging Rule Function PCRF will be handled accordingly as it is done for other policy interactions.

As an alternative both the user plane congestion detection rules as well as the user plane congestion control rules may be statically configured or even hardcoded in the respective user plane entities: Once a node in the mobile network detects a user plane congestion it will force a locally configured traffic engineering policy TEP to mitigate the congestion rather than sending the indication to the Policy and Charging Rule Function PCRF. Therefore deciding or selecting which traffic engineering policy to be used and also the traffic, bearers or the like for which the traffic engineering policies should be applied is performed by the user plane node itself. Such static detection and control rules may be preferably implemented in a base station. The base station will then detect a congestion based on receiving the ECN-echo indication from the packet data network gateway P-GW or the serving gateway S-GW and would enforce the locally configured traffic engineering policies on the uplink. Traffic engineering policies may be for example reflect fairness among user equipment, prioritization of delay sensitive traffic or the like.

In summary the present invention enables a user plane congestion detection and control wherein mobile network entities, for example a base station for downlink traffic and core network entities for uplink, indicate a congestion detected locally and/or through ECN marks of upstream nodes to corresponding sending entities, i.e. a core gateway in case of downlink and base station in case of uplink, at a granularity of bearers, user equipment or base stations/cells by adding congestion indication in the bearer-protocol headers, for example GTP/PMIP, of the user plane data packets. The core gateway entity upon receipt of a congestion indication then starts enforcing traffic engineering policies TEP, for example traffic shaping, rate limiting, priority based scheduling, etc. for data traffic of the same or different user equipment or bearers transmitted over the congested connections/paths. In case the mobile network supports dynamic policy control through a policy function, for example the Policy and Charging Rule Function PCRF, the core gateway entity informs the policy function once a congestion is detected so that the policy function may provide adequate traffic engineering policies to the core gateway entity as the enforcement point for the traffic engineering policies.

In case of a downlink congestion the base station delivers ECN-echo indication upon detection of downlink traffic that is ECN marked or if, for example the radio cell downlink is congested to mobile core network entities by setting a flag in the user plane data packets of corresponding uplink traffic, i.e. data traffic towards the same core gateway entities. Alternatively a congestion indicator to the GTP-echo messages may be added exchanged between GTP capable network entities. Further, the present invention enables mobile core network entities detecting downlink congestion in the mobile network through keeping track of ECN-echo counters for downlink and uplink user plane data traffic or alternatively by receiving a congestion indicator in the GTP-echo messages.

The present invention further enables core network entities enforcing locally available traffic engineering policies for downlink traffic once a downlink congestion has been detected and for uplink congestion without a base station congestion control support: The mobile core network entities may detect upload congestion in the mobile network by inspecting uplink data packets that are ECN marked and enforce traffic engineering policies for uplink traffic once uplink congestion has been detected. In case of uplink congestion this base station congestion control support mobile network entities deliver ECN-echo indications upon detection of uplink traffic that is ECN marked to a base station by setting a flag in the user plane data packets of corresponding downlink traffic, for example traffic towards the same base station or alternatively by adding a congestion indicator to the GTP-echo messages exchanged between GTP capable network entities.

The present invention further provides base stations which detect a congestion in the mobile network through keeping track of ECN/ECN-echo counters for uplink and downlink user plane data traffic or alternatively by receiving a congestion indicator in the GTP-echo message. The base station then enforces traffic engineering policies for uplink traffic once upload congestion has been detected.

The present invention further provides an ECN-echo indication set in the outer IP header, for example in an IPv4 option header or an IPv6 extension header or a GTP user plane header of corresponding GTP/PMIP bearers/tunnels. Further additional information could be signaled together with an ECN-echo message, for example cell ID/IP address, LAI, RAI, TAI, CSG, ECGI. Intermediary core network entities may then relay the ECN-echo indication together with additional information from the GTP bearer from the base station, for example S1 bearer to the corresponding core network bearer, for example S5/S8 bearer. The GTP-echo message may include a congestion indication and/or include information like cell-ID, IP address or the like about the GTP entity detecting a congestion. Intermediary GTP nodes, for example a serving gateway S-GW may relay the congestion indication by copying the added header fields from the GTP connection from the base station, for example S1 bearer, to the relevant GTP connection towards the packet data network gateway P-GW. A congestion detection and traffic engineering policies for uplink and downlink may be statically configured at mobile network core entities and/or base stations. The traffic engineering policies may be locally configured or hardcoded and may be autonomously enforced by core network nodes upon a congestion detection. In this case the “intelligence” would reside in the corresponding node itself to select or choose corresponding traffic engineering policies to be applied and the data traffic to which to apply them. Further congestion detection and traffic engineering policies for uplink and downlink may be dynamically provisioned by a mobile network policy function, for example a Policy and Charging Rule Function PCRF.

The mobile network policy function may provide user plane congestion detection rules to mobile network core entities to activate congestion detection. These mobile network policy functions may list different parameters, mention uplink and/or downlink only rules or combined uplink/downlink rules and clarify how an end of a congestion period can be detected. Further, the mobile network core entities may indicate to the mobile network policy function once uplink and/or downlink user plane congestion has been detected. Further, the mobile network policy function may select and/or derive adequate user plane congestion control rules that taking into account where, for example at what base station, a congestion occurs and what other traffic and/or from which user equipment is sent over that data transmission path. Further, the mobile network policy function may provision the user plane congestion control rules to mobile network core entities.

The mobile network core entities may then receive the user plane congestion control rules for uplink congestion signal then towards other entities on the data transmission path towards a base station, for example a serving gateway S-GW and/or a mobility management entity MME or all the way to the base station. Further, the mobile network core entities may receive the user plane congestion control rules for uplink congestion and signal them towards the user equipment, for example via the mobility management entity MME and non-access stratum signaling.

The present invention provides a holistic integrative method and system taking into account mobile network structure and is independent of any protocol support. A further advantage of the present invention is that the method and the system provides support for any traffic engineering policy or in general mobile network policies for congestion detection and traffic engineering.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1-19. (canceled)

20. A method for congestion avoidance in mobile communication networks, wherein the mobile communication network comprises a sender (S) and a receiver (R), wherein one of them is located in a mobile network, wherein the mobile network is connected to the a network of the mobile communication network, comprising the steps of
a) Detecting a congestion in a first communication plane (UP) of the mobile communication network between the sender (S) and the receiver (R),
b) Providing a congestion notification (CN) further downstream in the direction of a data transmission path between the sender (S) and the receiver (R),
c) Providing congestion notification information (CNI) on the opposite data transmission path on a second communication plane (CP) of the mobile communication network and
d) Initiating one or more congestion avoidance actions (TEP),
wherein
the congestion notification (CN) according to step b) and the congestion notification information according to step c) are transmitted between mobile network entities (BS, IN, EE), wherein the data transmission path and the opposite data transmission path are on the same communication plane (UP) and
the congestion notification information (CNI) according to step c) is provided to an action entity (PCRF) in the other of the communication planes (CP) for performing step d).

21. The method according to claim 19, wherein the congestion notification (CN) according to step b) and/or the congestion notification information (CNI) according to step c) is transmitted between mobile network entities (BS, IN, EE) are in form of edge entities (EE) of the mobile network.

22. The method according to claim 19, wherein the entity providing the congestion notification information (CNI) adds mobile network related information into the congestion notification information, preferably mobile network entity related information.

23. The method according to claim 19, wherein one or more congestion avoidance actions (TEP) for initiation are chosen based on the mobile network related information.

24. The method according to claim 19, wherein the congestion avoidance action includes imposing traffic engineering policies (TEP) and/or Quality of Service policies.

25. The method according to claim 19, wherein a congestion is detected on a bearer, tunnel and/or flow granularity level in the first communication plane (UP).

26. The method according to claim 19, wherein the congestion notification information (CNI) is provided in form of an echo message of the congestion notification (CN).

27. The method according to claim 19, wherein the one or more congestion avoidance actions (TEP) are imposed at least partly on bearers, tunnels and/or flows other than those for which a congestion was detected.

28. The method according to claim 19, wherein congestion notification information (CNI) and/or congestion notification (CN) is included into the data transmission between sender (S) and receiver (R).

29. The method according to claim 19, wherein congestion notification information (CNI) and/or congestion notification (CN) is included into signaling messages between mobile network entities (BS, EE, IE).

30. The method according to claim 19, wherein congestion notification information (CNI) and/or congestion notifications (CN) are provided repeatedly as long as a congestion is present.

31. The method according to claim 19, wherein the one or more congestion avoidance actions (TEP) are initiated when a counting threshold for a number of congestion notification information (CNI) and/or congestion notifications (CN) is exceeded during a certain time interval.

32. The method according to claim 19, wherein the congestion notification information (CNI) and/or congestion notifications (CN) are provided with a pregiven frequency when a congestion is present.

33. The method according to claim 19, wherein congestion notification information (CNI) and/or congestion notifications (CN) include start and/or stop congestion indication commands.

34. The method according to claim 19, wherein a congestion and/or end of congestion is determined by comparing a number of congestion notification information (CNI) and a number of congestion notifications (CN).

35. The method according to claim 19, wherein congestion notification information (CNI) and/or congestion notification (CN) is included in data packets, preferably included as an additional IPv4 option and/or as an additional IPv6 extension header and/or a new GTP header field.

36. The method according to claim 34, wherein the numbers of congestion notifications (CN) and of congestion notification information (CNI) are provided as percentage values representing the fraction of data traffic packets with and without congestion notification (CN) and congestion notification information (CNI).

37. The method according to claim 19, wherein the congestion avoidance actions (TEP) are locally and/or statically configured.

38. A system for congestion avoidance in mobile communication networks, wherein the mobile communication network comprises a sender (S) and a receiver (R), wherein one of them is located in a mobile network, wherein the mobile network is connected to a core network of the mobile communication network, preferably for performing with a method according to claim 19, and wherein the mobile network comprises at least one intermediate entity (IE) and at least one action entity (PCRF), wherein at least one of the intermediate entities (IE) is configured to be operable to detect a congestion in a first communication plane (UP) of the mobile communication network between the sender (S) and the receiver (R), and to provide a congestion notification (CN) further downstream in the direction of a data transmission path between the sender (S) and the receiver (R), and wherein
one of the entities in the core network and/or in the mobile network is configured to be operable to provide congestion notification information (CNI) on the opposite data transmission path on a second communication plane (CP) of the mobile communication network and wherein
the action entity (PCRF) is configured to be operable to initiate one or more congestion avoidance actions (TEP), wherein
at least one of the entities (UE, BS) of the mobile network is configured to be operable to transmit the congestion notification (CN) and the congestion notification information (CNI) between mobile network entities (BS, IE, EE) only, wherein the data transmission path and the opposite data transmission path are on the same communication plane (UP) and
one of the entities (UE, BS, EE) of the mobile network is configured to be operable to provide the congestion notification information (CNI) to the action entity (PCRF) in the other of the communication planes (CP) for initiating one or more congestion avoidance actions (TEP).
